(19) United States
(12) Patent Application Publication
(10) Pub. No.: US 2006/0278333 A1
(43) Pub. Date: Dec. 14, 2006

(54) Method of manufacturing a flexible display device

(76) Inventors: Woo-Jae Lee, Yongin-si (KR); Mun-Pyo Hong, Seongnam-si (KR)

Correspondence Address: CANTOR COLBURN, LLP, 55 GRIFFIN ROAD SOUTH, BLOOMFIELD, CT, 06002, US

(21) Appl. No.: 11/440,901

(22) Filed: May 25, 2006

(30) Foreign Application Priority Data
May 27, 2005 (KR) 10-2005-0045022

(51) Int. Cl. B32B 37/00

(52) U.S. Cl. 156/263

(57) ABSTRACT

A method of manufacturing a flexible display is provided, which includes adhering a first flexible mother substrate to a first supporter, cutting the first flexible mother substrate to divide the first flexible mother substrate into a plurality of first substrates, and forming a thin film pattern on the first substrates. Thus, the production yield of a flexible display device may be improved and the manufacturing process is more precise and easier.

This application claims priority to Korean Patent Application No. 10-1005-0045022, filed on May 27, 2005 and all the benefits accruing therefrom under 35 U.S.C. §119, and the contents of which in its entirety are herein incorporated by reference.

### BACKGROUND OF THE INVENTION

(a) Field of the Invention

The present invention relates to a method of manufacturing a flexible display device, and more particularly, to a method of manufacturing a flexible display device including a plastic substrate.

(b) Description of the Related Art

A liquid crystal display (“LCD”) and an organic light emitting display (“OLED”) are widely used as flat panel displays.

An LCD includes first and second panels provided with field-generating electrodes such as pixel electrodes on the first panel and a common electrode on the second panel, polarizers, and a liquid crystal (“LC”) layer interposed between the field-generating electrodes. The LCD displays images by applying voltages to the field-generating electrodes to generate an electric field in the LC layer, which determines orientations of LC molecules in the LC layer to adjust the polarization of the incident light. The LCD is not a self-emissive device and requires a light source.

An organic light emitting diode display (“OLED”) is a self-emissive display device, which displays images by exciting an emissive organic material to emit light. The OLED includes an anode (hole injection electrode), a cathode (electron injection electrode), and an organic light emission layer interposed therebetween. When the holes and the electrons are injected into the light emission layer, they are recombined and the pair is annihilated while emitting light.

Because the LCD and the OLED include fragile and heavy glass substrates, they are not suitable for portability and large-scale display.

Accordingly, a display device using a flexible substrate such as plastic that is light and strong is recently developed.

However, because the plastic substrate has a property such that it bends and expands with heat, thin film patterns such as electrodes and signal lines are difficult to form thereon. To solve this problem, the plastic substrate is attached to a glass supporter, thin film patterns are formed on the plastic substrate, and then the plastic substrate is removed from the glass supporter.

In the above-described method, one plastic substrate is attached to the glass supporter to form thin film patterns thereon, and accordingly only one display device can be completed in one manufacturing process, so the production yield is remarkably reduced.

### BRIEF SUMMARY OF THE INVENTION

The present invention improves production yield and provides an accurate and easy manufacturing process in a manufacturing method of a flexible display device.

Exemplary embodiments of a method of manufacturing a flexible display device includes adhering a first flexible mother substrate to a first supporter, cutting the first flexible mother substrate to divide the first flexible mother substrate into a plurality of first substrates, and forming a thin film pattern on the first substrates.

The first flexible mother substrate may be made of a plastic material.

The method may further include adhering a second flexible mother substrate to a second supporter, cutting the second flexible mother substrate to divide the second flexible mother substrate into a plurality of second substrates, forming a thin film pattern on the second substrates, combining the first and the second substrates, respectively attached to the first and the second supporters, cutting the first and the second supporters along a cutting line of the first and the second substrates, and removing the first and the second supporters from the first and the second substrates.

The method may further include adhering a second flexible mother substrate to a second supporter, cutting the second flexible mother substrate to divide into a plurality of second substrates, forming a thin film pattern on the second substrates, combining the first and the second substrates, respectively attached to the first and the second supporters. and removing the first and the second supporters from the first and the second substrates to respectively divide the first and second substrates into substrate pairs.

The method may further include forming a liquid crystal layer between the first and the second substrates.

The method may further include reducing an adhesive strength between the first and second supporters and the first and second substrates prior to removing the first and second supporters from the first and second substrates, respectively. Reducing the adhesive strength may include one of controlling temperature, using solvent, and irradiating ultra violet rays.

The first flexible mother substrate may be attached to the first supporter using a double-sided adhesive tape in the adhesion step.

The first flexible mother substrate and the adhesive tape may be cut together in the cutting step.

The first flexible mother substrate may be cut using a laser cutter.

The first flexible substrate may be coated by a hard-coating layer.

The hard-coating layer may include acrylic resin.

The flexible substrate may include an organic layer, an under-coating layer formed on both surfaces of the organic layer, a barrier layer formed on the under-coating layer, and a hard-coating layer formed on the barrier layer.

The organic layer may be made of one material selected from polyacrylate, polyethylene-ether-phthalate, polyethylene-naphthalate, polycarbonate, polyarylate, polyether-imide, polyethersulfone, and polyimides.

The under-coating layer and the hard-coating layer may include acrylic resin.

The barrier layer may include SiO₂ or A1₂0₃.

The first supporter may include glass.

The thin film pattern may include an inorganic emitting layer.

The thin film pattern may include amorphous silicon thin film transistors.

The thin film pattern may include organic thin film transistors.

The formation method of the thin film pattern may include spin coating.

The first supporter may not be divided during cutting the first flexible mother substrate to divide the first flexible mother substrate into a plurality of first substrates.

A plurality of flexible display devices may be substantially simultaneously formed, where each flexible display device includes one of the first substrates.

Other exemplary embodiments of a method of manufacturing a plurality of flexible display devices includes adhering a plurality of first flexible substrates to a first supporter, forming a thin film pattern on the plurality of first flexible substrates, removing a plurality of display device units from the first supporter, wherein each display device unit includes one of the plurality of first flexible substrates.

Adhering the plurality of first flexible substrates to a first supporter may include providing a first supporter of an inflexible material having a greater periphery than a periphery of the plurality of first flexible substrates arranged on the first supporter.

The method may further include adhering a plurality of second flexible substrates to a second supporter, forming a thin film pattern on the plurality of second flexible substrates, and combining the first and the second flexible substrates, respectively attached to the first and second supporters, wherein removing the plurality of display device units from the first supporter further includes removing the plurality of display device units from the second supporter, each display device unit including one of the plurality of first flexible substrates and one of the plurality of second flexible substrates.

The method may further include dividing the first and second supporters along lines between adjacent first flexible substrates and adjacent second flexible substrates, respectively, prior to removing the plurality of display device units from the first supporter and the second supporter.

### BRIEF DESCRIPTION OF THE DRAWINGS

The above and other advantages of the present invention will become more apparent by describing preferred embodiments thereof in detail with reference to the accompanying drawings, in which:

FIG. 1A is a plan view, FIG. 1B is a sectional view taken along line IB-IB in FIG. 1A, and FIGS. 1C to 1G are additional sectional views illustrating an exemplary embodiment of a manufacturing method of an exemplary flexible display device according to the present invention;

FIGS. 2A and 2B are sectional views, FIG. 2C is a plan view, FIG. 2D is a sectional view taken along line IID-IID in FIG. 2C, and FIGS. 2E to 21 are additional sectional views illustrating another exemplary embodiment of a manufacturing method of an exemplary flexible display device according to the present invention;

FIG. 3 is a layout view of an exemplary embodiment of an LCD according to the present invention;

FIGS. 4A and 4B are sectional views of the exemplary LCD shown in FIG. 3 taken along lines IVA-IVA and IVB-IVB;

FIGS. 5, 7, 9, and 11 are layout views of an exemplary TFT array panel shown in FIGS. 3, 4A, and 4B in intermediate steps of an exemplary embodiment of a manufacturing method thereof according to the present invention;

FIGS. 6A and 6B are sectional views of the exemplary TFT array panel shown in FIG. 5 taken along lines VIA-VIA and VIB-VIB;

FIGS. 8A and 8B are sectional views of the exemplary TFT array panel shown in FIG. 7 taken along lines VIIIA-VIIIA and VIIIB-VIIIB;

FIGS. 10A and 10B are sectional views of the exemplary TFT array panel shown in FIG. 9 taken along lines XA-XA and XB-XB;

FIGS. 12A and 12B are sectional views of the exemplary TFT array panel shown in FIG. 11 taken along lines XIA-XIA and XIB-XIB; and

FIGS. 13A to 13D are sectional views of a common electrode panel in intermediate steps of an exemplary embodiment of a manufacturing method thereof according to the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. In the drawings, the thickness of layers, films, and regions are exaggerated for clarity.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

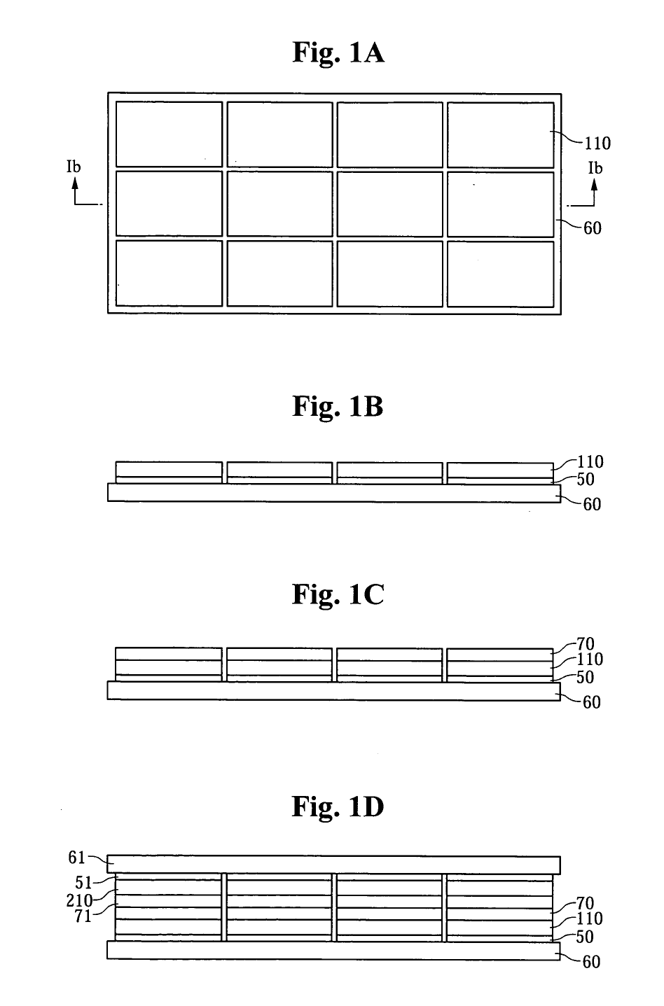

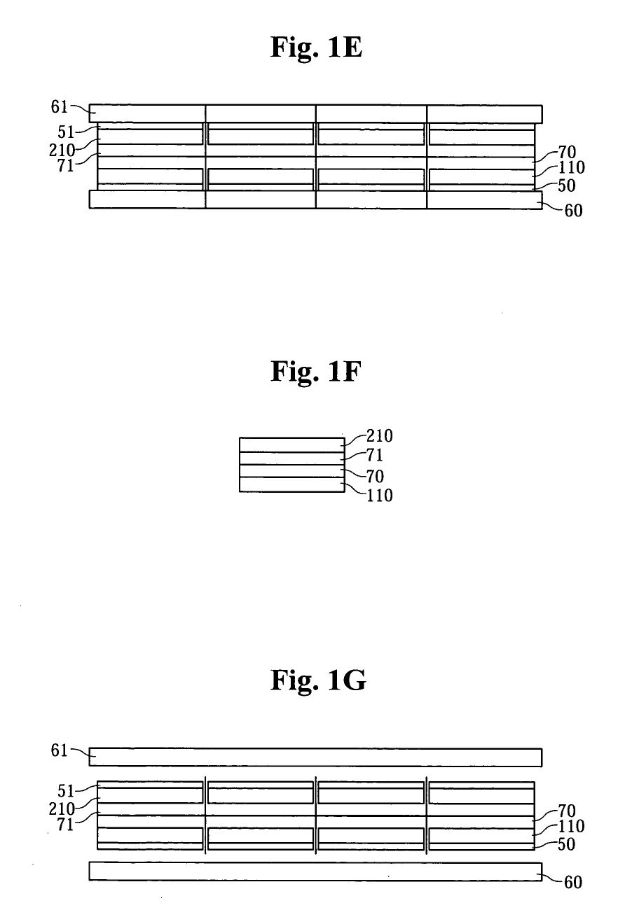

Now, exemplary embodiments of a method of manufacturing an exemplary flexible display device according to the present invention will be described in detail with reference to FIGS. 1A to 1G.

FIG. 1A is a plan view, FIG. 1 B is a sectional view taken along line IB-IB in FIG. 1A, and FIGS. 1C to 1G are additional sectional views illustrating an exemplary embodiment of a manufacturing method of an exemplary flexible display device according to the present invention.

Referring to FIGS. 1A and 1B, one side of a double sided adhesive member 50 is attached to one surface of a plurality of flexible substrates 110 made of a plastic material, and the other surface of the double-sided adhesive member 50 is attached to a supporter 60. The pluralities of flexible substrates 110 are arranged at uniform intervals. A plurality of adhesive members 50 may be provided, each having substantially the same size as each flexible substrate 110. Alternatively, a single adhesive member 50 may be provided having a periphery such that all of the flexible substrates 110 may be disposed on the one surface of the adhesive member 50.

Each flexible substrate 110 has the predetermined size of a display device, such as a liquid crystal display (“LCD”) or an organic light emitting display (“OLED”). Accordingly, the production yield of the display device may be improved as a plurality of display devices are produced at substantially the same time, and bending of each flexible substrate 110 by stress due to different thermal expansion rates of the supporter 60 and each flexible substrate 110 may be reduced.

The flexible substrate 110 includes an organic layer made of one material selected from polyacrylate, polyethylene-ether-phthalate, polyethylene-naphthalate, polycarbonate, polyarylate, polyether-imide, polyethersulfone, and polyimides. The flexible substrate 110 may further include an under-coating layer (not shown) made of acrylic resin, a barrier layer (not shown) of SiO2 or Al2O3, and a hard-coating layer made of acrylic resin, which are formed on both surfaces, such as a lower surface facing the adhesive member 50 and an opposite upper surface, of the flexible substrate 110. These layers play a role in preventing the flexible substrate 110 from physical and chemical damage.

The adhesive member 50 may be a double-sided adhesive tape, including a polyimide film with adhesive formed on both surfaces of the polyimide film, and the adhesive of the adhesive member 50 may be a temperature sensitive adhesive of which the adhesive strength is eliminated at a high or low temperature, an acrylic adhesive, or a silicone adhesive.

The supporter 60 may be made of glass, although other relatively inflexible materials may also be within the scope of these embodiments.

Referring to FIG. 1C, a thin film pattern 70 is formed on the flexible substrate 110 attached to the supporter 60 via the adhesive member 50. At this time, because the flexible substrate 110 is solidly adhered to the supporter 60, the flexible substrate 110 does not bend or expand.

Referring to FIG. 1D, the flexible substrate 110 including the thin film pattern 70 and attached to the supporter 60 is combined with another flexible substrate 210 including a thin film pattern 71 and attached to another supporter 61 by adhesive member 51. At this time, the step of forming a liquid crystal layer (not shown) by dripping liquid crystal material on one of the two flexible substrates 110 and 210 may be added before combining the two flexible substrates 110 and 210 together. Alternatively, liquid crystal material may be injected between the substrates after the individual display device units are formed. Because an OLED uses one substrate, the process of including liquid crystal material may be omitted, and the thin film pattern 71 may then include an organic emitting layer.

Referring to FIG. 1E, the supporters 60 and 61 are divided into display device units, each display device unit including a pair of flexible substrates 110 and 210, and the supporters 60 and 61 are respectively removed from the flexible substrates 110 and 210 to complete each display device, where one display device is shown in FIG. 1F.

Alternatively, as a substitute for the step of FIG. 1E, and as shown in FIG. 1G, rather than dividing the supporters 60 and 61, the supporters 60 and 61 may be firstly removed from the plurality of flexible substrates 110 and 210, and the flexible substrates 110 and 210 including the thin film patterns 70 and 71 may then be divided into display device units.

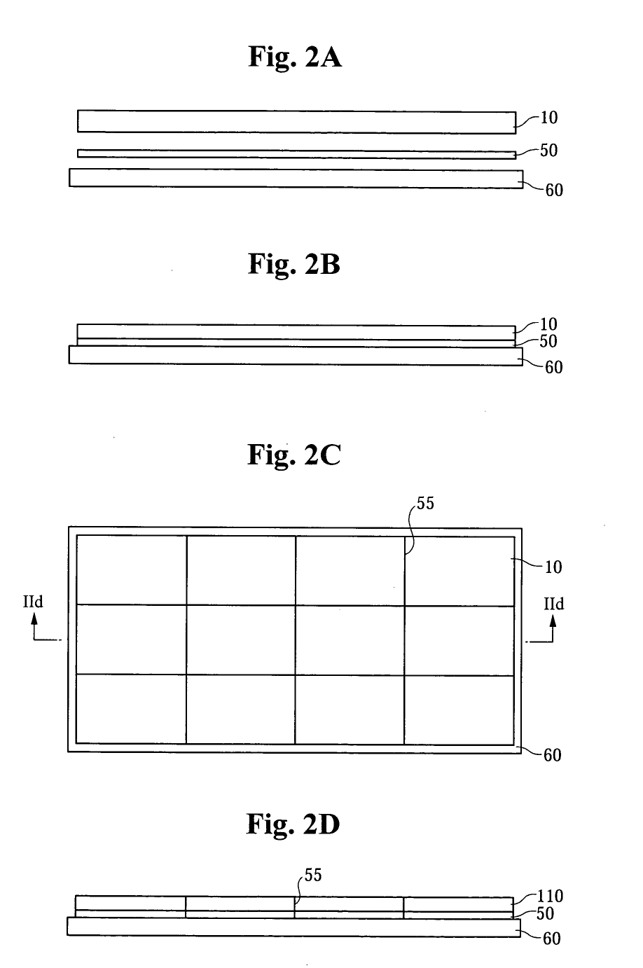

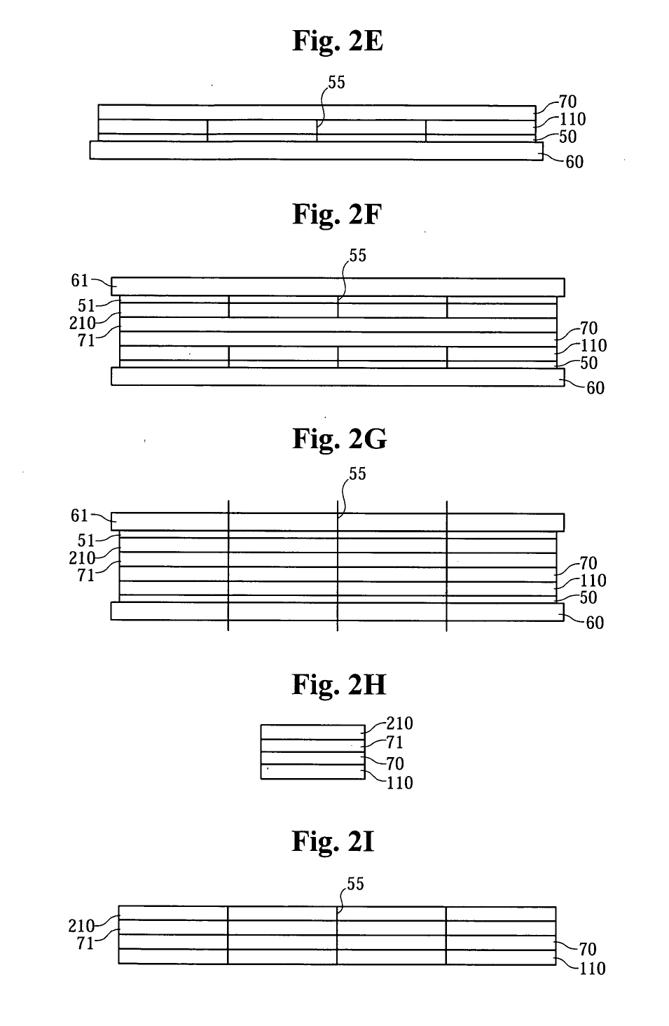

Next, another exemplary embodiment of a method of manufacturing an exemplary flexible display device according to the present invention will be described with reference to FIGS. 2A to 21.

FIGS. 2A and 2B are sectional views, FIG. 2C is a plan view, FIG. 2D is a sectional view taken along line IID-IID in FIG. 2C, and FIGS. 2E to 21 are additional sectional views illustrating another exemplary embodiment of a manufacturing method of an exemplary flexible display device according to the present invention.

Referring to FIG. 2A, one side, such as an upper surface, of a double-sided adhesive member 50 is attached to one surface, such as a lower surface, of one mother flexible substrate 10 made of a plastic material, and the other side, such as a lower surface, of the double-sided adhesive member 50 is attached to an upper surface of a supporter 60, as shown in FIG. 2B. At this time, the size of the plastic mother flexible substrate 10 is equal to or less than the size of the supporter 60, for adequately supporting all areas of the mother flexible substrate 10. The adhesive member 50 has substantially the same size as the mother flexible substrate 10. The adhesive member 50 and the supporter 60 may be the same as that of FIG. 1A.

Referring to FIGS. 2C and 2D, the plastic mother flexible substrate 10 attached to the supporter 60 is divided into a plurality of flexible substrates 110 along cutting lines 55 with the predetermined size of a display device. Here, the adhesive member 50 is divided as well as the plastic mother flexible substrate 10. In this process, the labor to align the plurality of flexible substrates 110 when attaching them on the supporter 60 may be reduced, and misalignment generated in the formation process of thin films, which are formed on the flexible substrate 110, may be prevented. Also, because only one plastic mother flexible substrate 10 is attached to the supporter 60, the use of a jig is unnecessary and the attachment process may be easy.

It is preferable that the cutting of the mother flexible substrate 10 and the adhesive member 50 along the cutting lines 55 is done using a laser cutter. The laser cutter prevents adhesion between the flexible substrate 110 and the supporter 60 from deteriorating due to bubbles generated in the inner portion of the cutting lines 55, such that the flexible substrates 110 do not become loose from the supporter 60. Furthermore, the laser cutter may control the width of the cutting lines 55 within the range of several tens to several hundreds of microns. The mother flexible substrate 10 with a similar size to the supporter 60 may be cut into the plurality of flexible substrates 110, which are arranged with accuracy and precise intervals. Furthermore, the laser cutter burns the adhesive member 50 such that the process is easier.

Referring to FIG. 2E, a plurality of thin film patterns 70 are formed on the plurality of flexible substrates 110 attached to the supporter 60. At this time, because each flexible substrate 110 is solidly adhered to the supporter 60, the flexible substrates 110 do not bend or expand. In addition, the step of forming the thin film patterns 70 may include a step of spin coating. Because the plurality of flexible substrates 110 are arranged with precise intervals, although the spin coating is executed to form the thin film patterns 70, the material that is used to form the thin film patterns 70 is not excessively interposed in the cutting lines 55.

Referring to FIG. 2F, the flexible substrates 110, each including the thin film pattern 70 and attached to the supporter 60 as shown in FIG. 2E, are combined with another plurality of flexible substrates 210, each including a thin film pattern 71 and attached to the supporter 61 via adhesive member 51. At this time, the step of forming a liquid crystal layer (not shown) by dripping liquid crystal material on one of the two flexible substrates 110 and 210 may be added before combining the two flexible substrates 110 and 210. The liquid crystal material may alternatively be injected between the two substrates after the individual display device units are formed. Because an OLED uses one substrate, the process of including liquid crystal material may be omitted, and the thin film pattern 71 may then include an organic emitting layer (not shown).

Referring to FIG. 2G, the supporters 60 and 61 are divided into display device units along the cutting lines 55 of the flexible substrates 110 and 210, and the pieces of the supporters 60 and 61, which are attached to the upper and the lower surfaces of the flexible substrates 110 and 210, are respectively removed from the flexible substrates 110 and 210 to complete a plurality of display devices, where one display device is shown in FIG. 2H.

Alternatively, as a substitute for the step of FIG. 2G, and as shown in FIG. 21, rather than dividing the supporters 60 and 61 along the cutting lines 55, the supporters 60 and 61 may be firstly removed from the flexible substrates 110 and 210, and the flexible substrates 110 and 210 including the thin film patterns 70 and 71 may be divided into display device units.

The flexible substrates 110 and 210 may be used as a panel of a display device such as an LCD and an OLED.

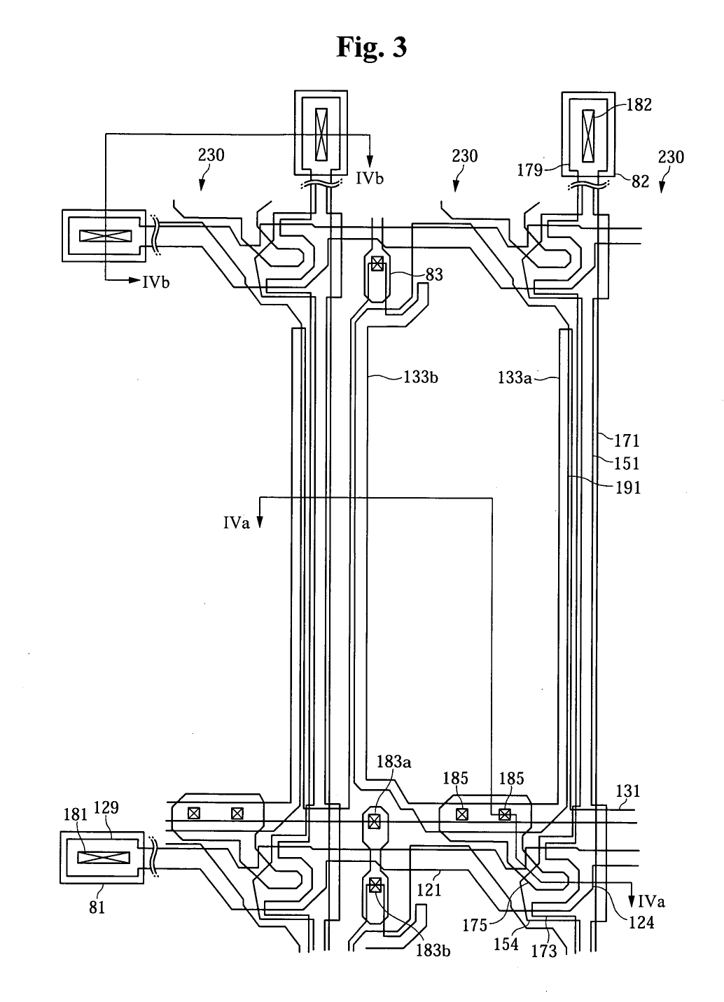

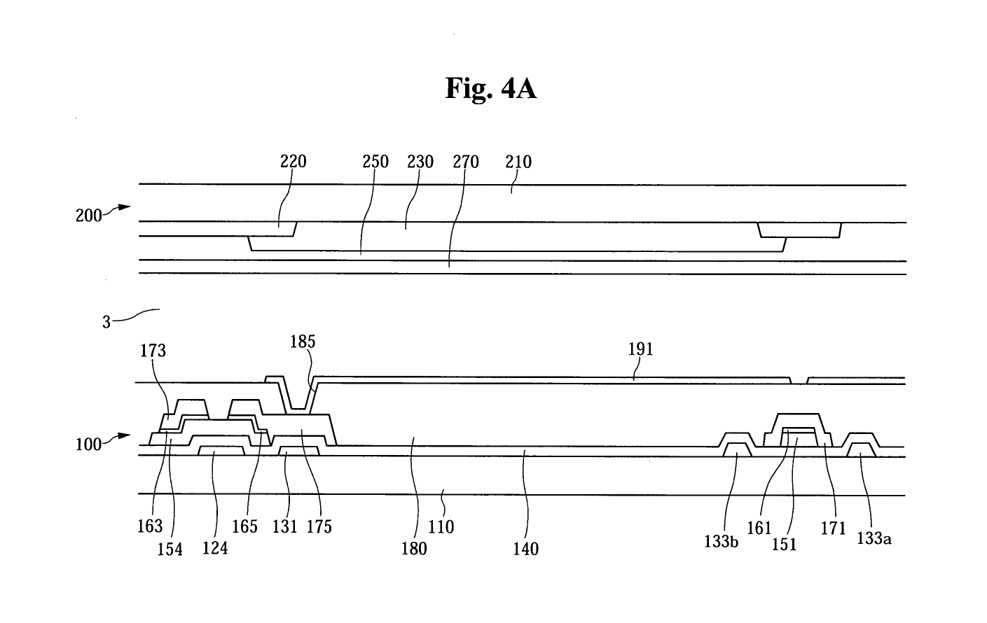

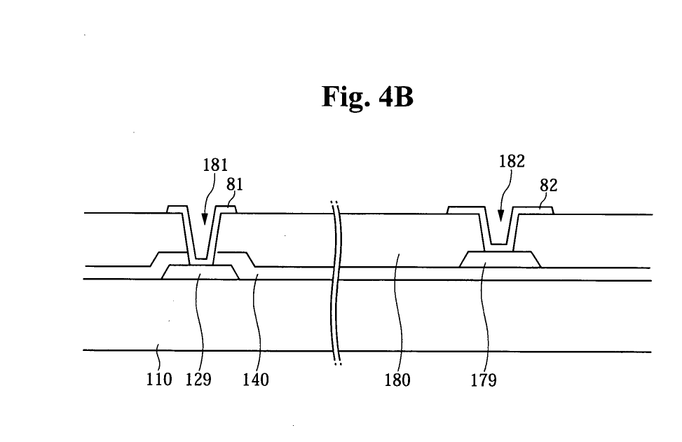

FIG. 3 is a layout view of an exemplary embodiment of an LCD according to the present invention, and FIGS. 4A and 4B are sectional views of the exemplary LCD shown in FIG. 3 taken along lines IVA-IVA and IVB-IVB.

As shown in FIGS. 3-4B, an LCD includes a TFT array panel 100, a common electrode panel 200 opposite the TFT array panel 100, and an LC layer 3 interposed between the panels 100 and 200.

Firstly, the TFT array panel 100 will be described.

A plurality of gate lines 121 and a plurality of storage electrode lines 131 are formed on a flexible substrate 110, such as a plastic substrate. The flexible substrate 110 may further be insulating and transparent.

The gate lines 121 transmit gate signals and extend substantially in a transverse direction, a first direction. Each of the gate lines 121 includes a plurality of gate electrodes 124 projecting downward, in a second direction, and an end portion 129 having a large area for contact with another layer or an external driving circuit. A gate driving circuit (not shown) for generating the gate signals may be mounted on a flexible printed circuit (“FPC”) film (not shown), which may be attached to the flexible substrate 110, directly mounted on the flexible substrate 110, or integrated onto the flexible substrate 110. Alternatively, the gate lines 121 may extend to be connected to a driving circuit that may be directly integrated on the flexible substrate 110.

The storage electrode lines 131 are supplied with a predetermined voltage, and each of the storage electrode lines 131 includes a stem extending substantially parallel to the gate lines 121 in the first direction and a plurality of pairs of storage electrodes 133a and 133b branched from the stems and extending in a second direction, substantially perpendicular to the first direction. Each of the storage electrode lines 131 is disposed between two adjacent gate lines 121 and the stem for each pixel area is positioned closer to one of the two adjacent gate lines 121. Each of the storage electrodes 133a and 133b has a fixed end portion connected to the stem and a free end portion disposed opposite thereto on an opposite side of the pixel area. The fixed end portion of the storage electrode 133b has a large area and the free end portion thereof is bifurcated into a linear branch and a curved branch. However, the storage electrode lines 131 may have various shapes and arrangements and are not limited to the illustrated exemplary embodiments.

The gate lines 121 and the storage electrode lines 131 are preferably made of an aluminum Al-containing metal such as Al and an Al alloy, a silver Ag-containing metal such as Ag and an Ag alloy, a copper Cu-containing metal such as Cu and a Cu alloy, a molybdenum Mo containing metal such as Mo and an Mo alloy, chromium Cr, tantalum Ta, or titanium Ti. The gate lines 121 and the storage electrode lines 131 may alternatively have a multi-layered structure including two conductive films (not shown) having different physical characteristics. If a multi-layered structure is employed, one of the two films is preferably made of a low resistivity metal such as an Al-containing metal, an Ag-containing metal, and a Cu-containing metal for reducing signal delay or voltage drop and the other film is preferably made of a material such as a Mo-containing metal, Cr, Ta, or Ti, which have good physical, chemical, and electrical contact characteristics with other materials such as indium tin oxide (“ITO”) or indium zinc oxide (“IZO”). Examples of the combination of the two films in a multi-layered structure include a lower Cr film and an upper Al (alloy) film and a lower Al (alloy) film and an upper Mo (alloy) film. However, the gate lines 121 and the storage electrode lines 131 may be made of various metals or conductors.

The lateral sides of the gate lines 121 and the storage electrode lines 131 are inclined relative to a surface of the flexible substrate 110, and the inclination angle thereof ranges about 30 to about 80 degrees.

A gate insulating layer 140 preferably made of, but not limited to, silicon nitride (SiNx) or silicon oxide (SiOx) is formed on the gate lines 121 and the storage electrode lines 131. The gate insulating layer 140 may further be formed over exposed portions of the flexible substrate 110.

A plurality of semiconductor stripes 151 preferably made of hydrogenated amorphous silicon (“a-Si”), polysilicon, or an organic semiconductor are formed on the gate insulating layer 140. Each of the semiconductor stripes 151 extends substantially in the longitudinal direction, the second direction parallel with the storage electrodes 133a and 133b, and includes a plurality of projections 154 branched out toward the gate electrodes 124. The semiconductor stripes 151 become wide near the gate lines 121 and the storage electrode lines 131 such that the semiconductor stripes 151 cover large areas of the gate lines 121 and the storage electrode lines 131.

A plurality of ohmic contacts, including ohmic contact stripes and islands 161 and 165, are formed on the semiconductor stripes 151. The ohmic contact stripes and islands 161 and 165 are preferably made of n+hydrogenated a-Si heavily doped with an N-type impurity such as phosphorous, or they may be made of silicide. Each ohmic contact stripe 161 includes a plurality of projections 163, and the projections 163 and the ohmic contact islands 165 are located in pairs on the projections 154 of the semiconductor stripes 151 and spaced apart from each other to form a channel on the projections 154.

The lateral sides of the semiconductor stripes 151 and the ohmic contacts 161 and 165 are tapered relative to the surface of the flexible substrate 110, and the inclination angles thereof are preferably in a range between about 30 to about 80 degrees.

A plurality of data lines 171 and a plurality of drain electrodes 175 are formed on the ohmic contacts 161 and 165 and the gate insulating layer 140.

The data lines 171 transmit data signals and extend substantially in the longitudinal direction, the second direction, to intersect the gate lines 121. The data lines 171 are insulated from the gate lines 121 by the gate insulating layer 140 disposed there between. Each data line 171 also intersects the storage electrode lines 131 and runs parallel between adjacent pairs of storage electrodes 133a and 133b. Each data line 171 includes a plurality of source electrodes 173 projecting toward the gate electrodes 124 and being curved like a crescent, and an end portion 179 having a large area for contact with another layer or an external driving circuit. A data driving circuit (not shown) for generating the data signals may be mounted on an FPC film (not shown), which may be attached to the flexible substrate 110, directly mounted on the flexible substrate 110, or integrated onto the flexible substrate 110. Alternatively, the data lines 171 may extend to be connected to a driving circuit that may be integrated on the flexible substrate 110.

The drain electrodes 175 are separated from the data lines 171 and disposed opposite the source electrodes 173 with respect to the gate electrodes 124, thus maintaining the channel over the projection 154. Each of the drain electrodes 175 includes a wide end portion and a narrow end portion. The wide end portion overlaps the storage electrode line 131 and the narrow end portion is partly enclosed by a source electrode 173.

A gate electrode 124, a source electrode 173, and a drain electrode 175 along with a projection 154 of a semiconductor stripe 151 form a TFT having a channel formed in the projection 154 disposed between the source electrode 173 and the drain electrode 175 and between the ohmic contact island 165 and the projection 163 of the ohmic contact stripe 161. When the semiconductor stripe 151 is made of an organic material, the TFT is an organic TFT.

The data lines 171 and the drain electrodes 175 are preferably made of a refractory metal such as Cr, Mo, Ta, Ti, or alloys thereof. However, the data lines 171 and the drain electrodes 175 may alternatively have a multilayered structure including a refractory metal film (not shown) and a low resistivity film (not shown). Examples of the multi-layered structure include, but are not limited to, a double-layered structure including a lower Cr/Mo (alloy) film and an upper Al (alloy) film and a triple-layered structure of a lower Mo (alloy) film, an intermediate Al (alloy) film, and an upper Mo (alloy) film. However, the data lines 171 and the drain electrodes 175 may be made of various metals or conductors.

The data lines 171 and the drain electrodes 175 have inclined edge profiles with respect to a surface of the flexible substrate 110, and the inclination angles thereof range about 30 to about 80 degrees.

The ohmic contacts 161 and 165 are interposed only between the underlying semiconductor stripes 151 and the overlying conductors 171 and 175 thereon and reduce the contact resistance therebetween. Although the semiconductor stripes 151 are narrower than the data lines 171 at most places, the width of the semiconductor stripes 151 becomes large near the gate lines 121 and the storage electrode lines 131 as described above, to smooth the profile of the surface, thereby preventing the disconnection of the data lines 171. However, the semiconductor stripes 151 include some exposed portions, which are not covered with the data lines 171 and the drain electrodes 175, such as portions located over the projections 154 between the source electrodes 173 and the drain electrodes 175, thus the exposed portions form channels.

A passivation layer 180 is formed on the data lines 171, the drain electrodes 175, and the exposed portions of the semiconductor stripes 151. The passivation layer 180 may be further formed on exposed portions of the gate insulating layer 140 as shown.

The passivation layer 180 is preferably made of an inorganic or organic insulator, and it may have a flat top surface. Examples of the inorganic insulator include, but are not limited to, silicon nitride and silicon oxide. The organic insulator may have photosensitivity and a dielectric constant of less than about 4.0. Alternatively, the passivation layer 180 may include a lower film of an inorganic insulator and an upper film of an organic insulator such that it possesses the excellent insulating characteristics of the organic insulator while preventing the exposed portions of the semiconductor stripes 151 from being damaged by the organic insulator.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121, a plurality of contact holes 183a exposing portions of the storage electrode lines 131 near the fixed end portions of the storage electrodes 133b, and a plurality of contact holes 183b exposing the linear branches of the free end portions of the storage electrodes 133b.

A plurality of pixel electrodes 191, a plurality of overpasses 83, and a plurality of contact assistants 81 and 82 are formed on the passivation layer 180. They may be made of a transparent conductor such as ITO or IZO, or a reflective conductor such as Ag, Al, Cr, or alloys thereof, such as for use in a reflective LCD.

The pixel electrodes 191 are physically and electrically connected to the drain electrodes 175 through the contact holes 185 such that the pixel electrodes 191 receive data voltages from the drain electrodes 175. The pixel electrodes 191 supplied with the data voltages generate electric fields in cooperation with a common electrode 270 of a common electrode panel 200 supplied with a common voltage, which determine the orientations of liquid crystal molecules (not shown) of a liquid crystal layer 3 disposed between the two electrodes 191 and 270. A pixel electrode 191 and the common electrode form a capacitor referred to as a “liquid crystal capacitor,” which stores applied voltages after the TFT turns off.

A pixel electrode 191 overlaps a storage electrode line 131 including storage electrodes 133a and 133b for improving an aperture ratio of each pixel. The pixel electrode 191 and a drain electrode 175 connected thereto and the storage electrode line 131 form an additional capacitor referred to as a “storage capacitor,” which enhances the voltage storing capacity of the liquid crystal capacitor.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179, respectively, and external devices, such as a gate driving circuit and a data driving circuit as previously described.

The overpasses 83 cross over the gate lines 121 and are connected to the exposed portions of the storage electrode lines 131 and the exposed linear branches of the free end portions of the storage electrodes 133b through the contact holes 183a and 183b, respectively, which are disposed opposite each other with respect to the gate lines 121. That is, each overpass 83 spans between two adjacent pixels. Thus, each pixel includes a portion of a first overpass 83 at a lower portion of the pixel area and a portion of a second overpass 83 at an upper portion of the pixel area. The storage electrode lines 131 including the storage electrodes 133a and 133b along with the overpasses 83 can be used for repairing defects in the gate lines 121, the data lines 171, or the TFTs.

The common electrode panel 200 will now be described.

A light blocking member 220, also termed a black matrix, for preventing light leakage between pluralities of pixels is formed on a flexible substrate 210 such as a plastic substrate. The flexible substrate 210 may further be transparent and insulating. The light blocking member 220 may include a plurality of openings that face the pixel electrodes 191. Otherwise, the light blocking member 220 may include a plurality of portions facing the gate lines 121 and data lines 171 on the TFT array panel 100 and a plurality of widened portions facing the TFTs on the TFT array panel 100.

A plurality of color filters 230 are formed on the flexible substrate 210 and they are disposed substantially in the areas enclosed by the light blocking member 220. The color filters 230 may extend substantially along the longitudinal direction along the pixel column such that they may form stripes. The color filters 230 may each represent one color such as red, green, and blue colors.

An overcoat 250 for preventing the color filters 230 from being exposed and for providing a flat surface is formed on the color filters 230 and the light blocking member 220. The overcoat 250 may be made of an organic insulator. Alternatively, the overcoat 250 may be omitted.

A common electrode 270 preferably made of a transparent conductive material such as, but not limited to, ITO or IZO is formed on the overcoat 250.

Alignment layers (not shown) that may be horizontal or vertical alignment layers are respectively formed on the inner surface of the two panels 100 and 200, and polarizers are provided on the outer sides of the two panels 100 and 200 so that their polarization axes may cross perpendicularly with respect to each other and one of the polarization axes may be parallel to the gate lines 121. Alternatively, one of the polarizers may be omitted when the LCD is a reflective LCD.

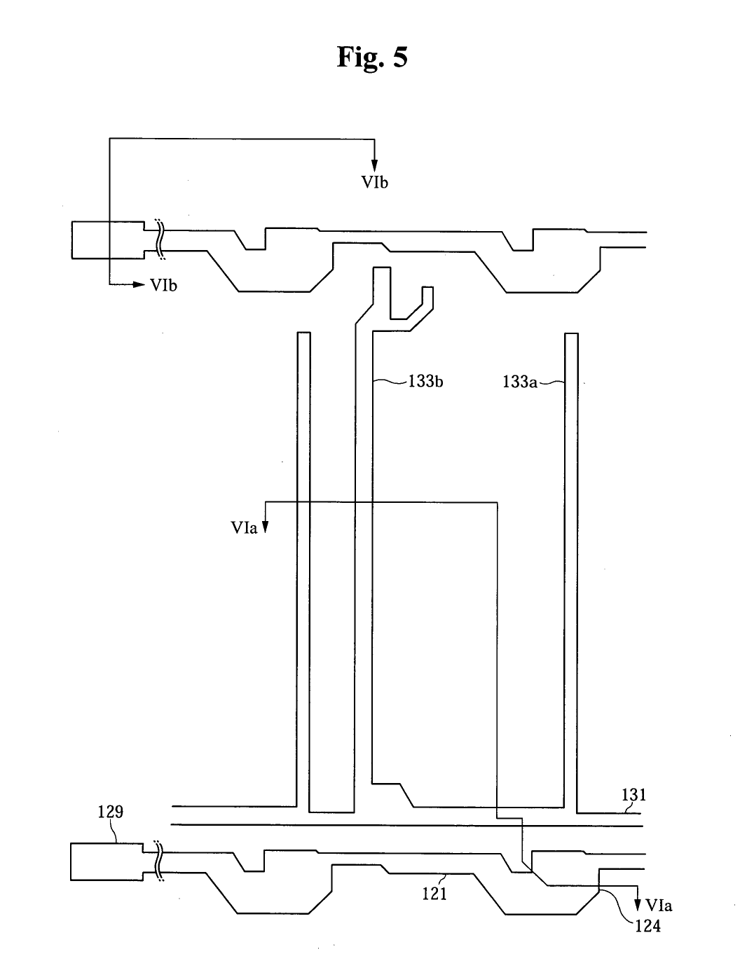

Now, an exemplary embodiment of a method of manufacturing the TFT array panel 100 shown in FIGS. 3-4B according to the present invention will be described with reference to FIGS. 5-12B as well as FIGS. 3-4B.

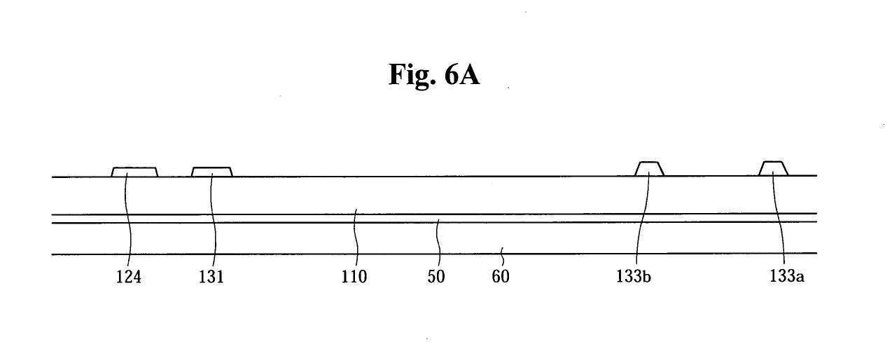

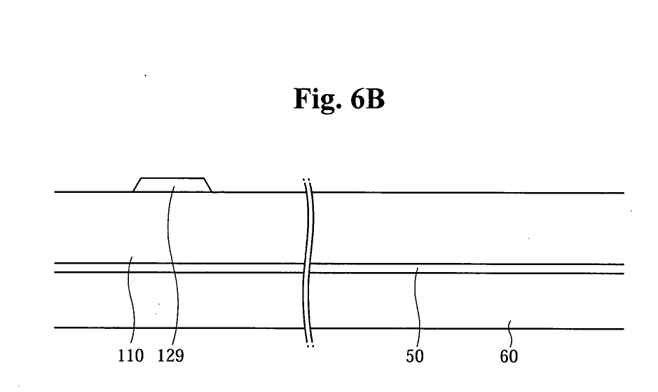

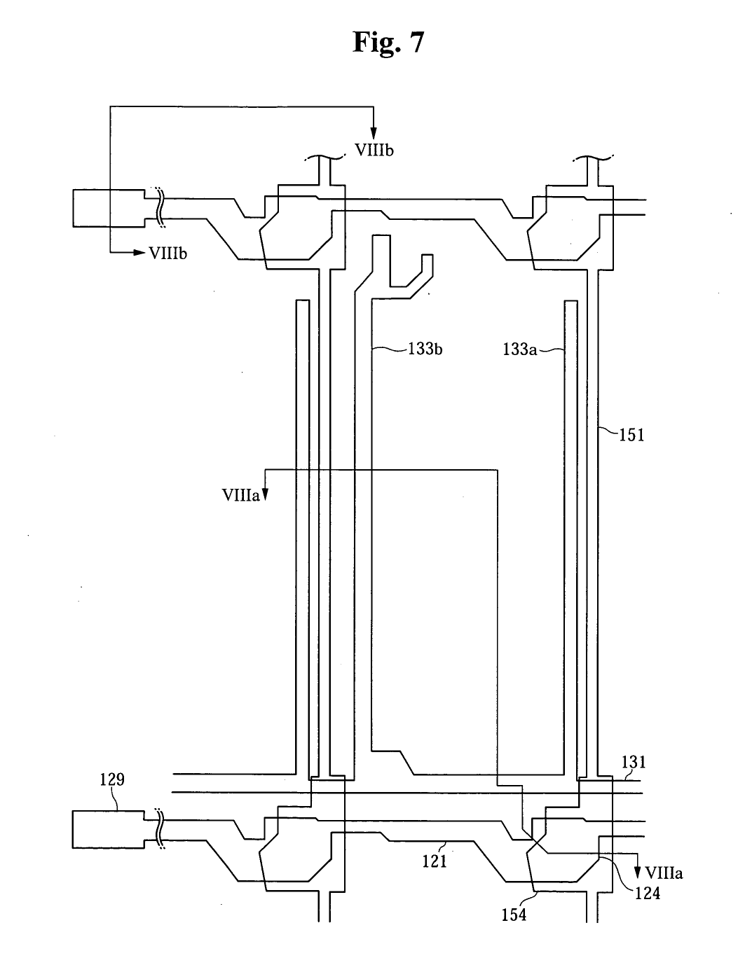

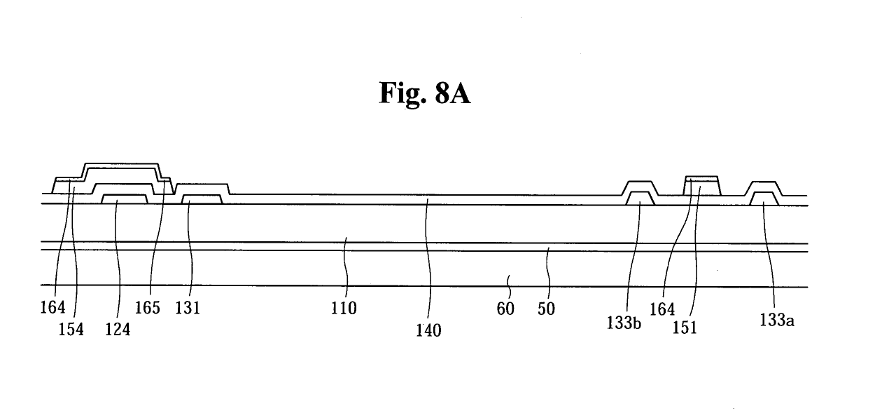

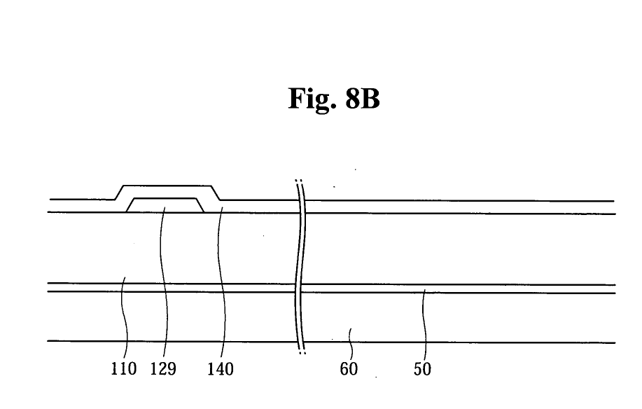

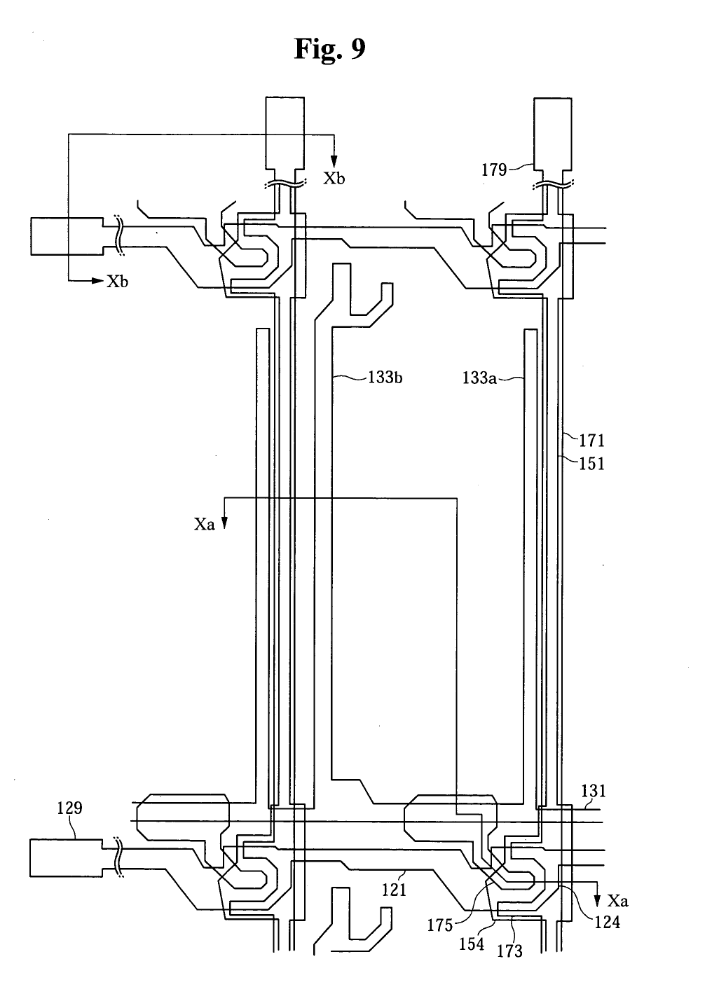

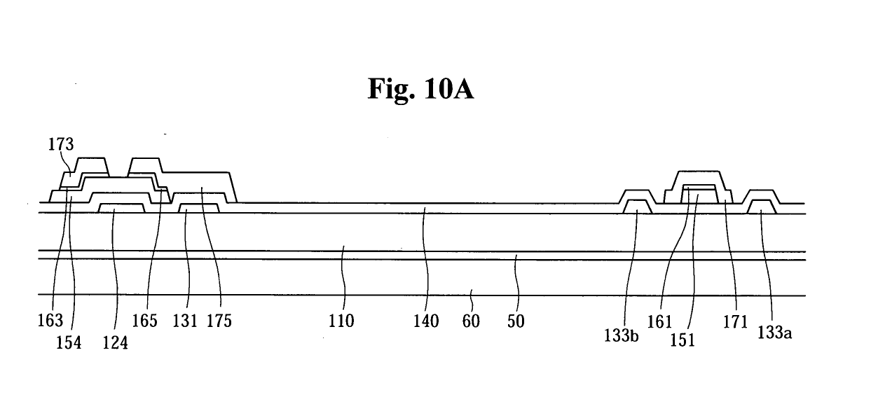

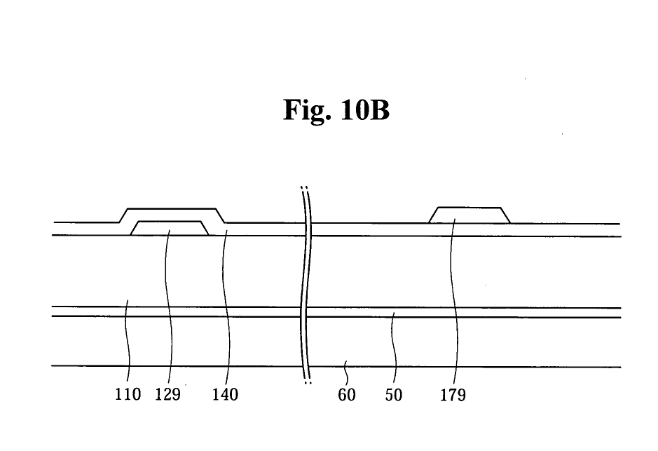

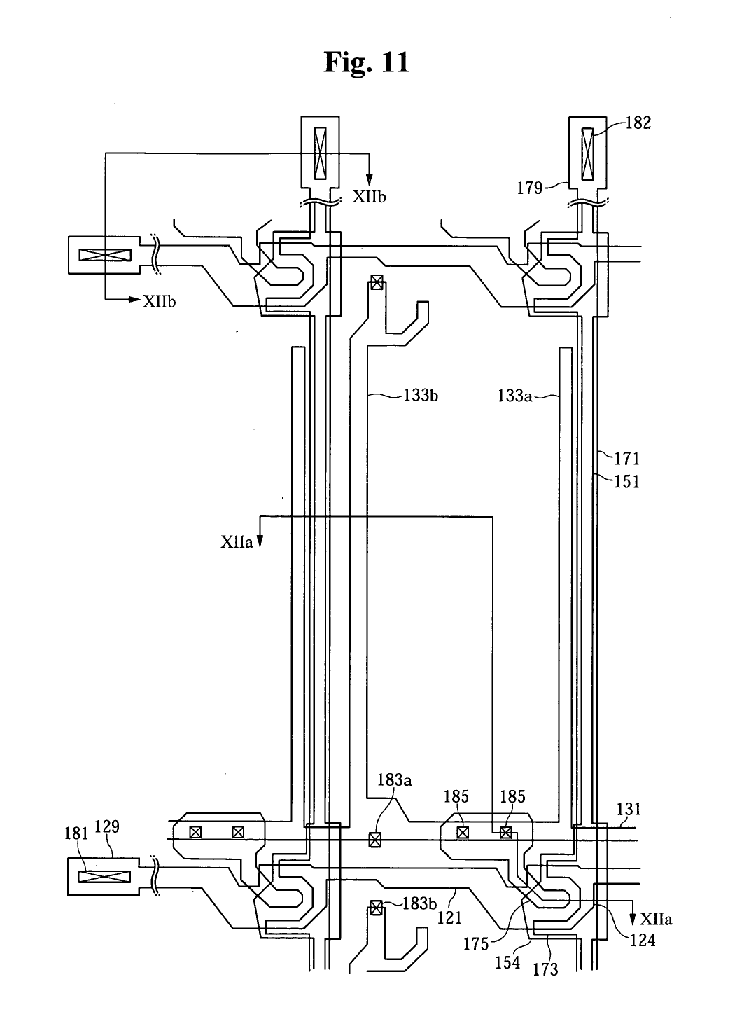

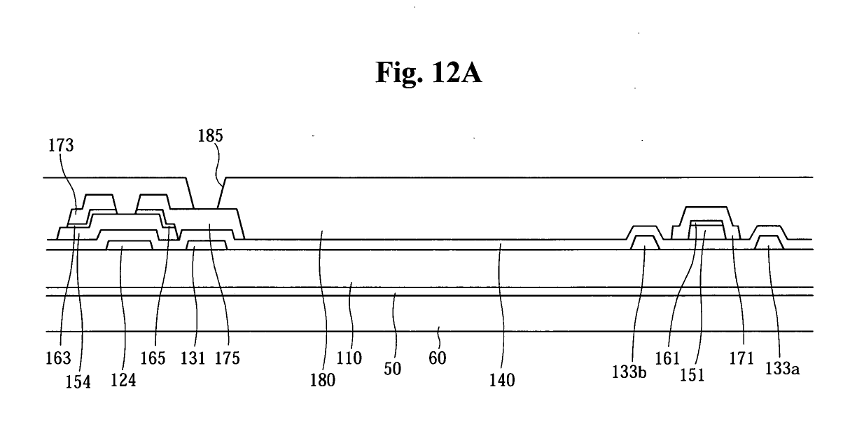

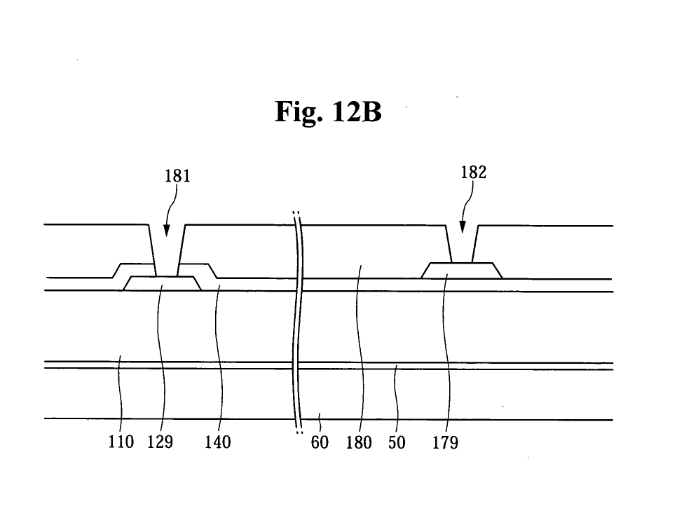

FIGS. 5, 7, 9, and 11 are layout views of an exemplary TFT array panel shown in FIGS. 3, 4A, and 4B in intermediate steps of an exemplary embodiment of a manufacturing method thereof according to the present invention, FIGS. 6A and 6B are sectional views of the exemplary TFT array panel shown in FIG. 5 taken along lines VIA-VIA and VIB-VIB, FIGS. 8A and 8B are sectional views of the exemplary TFT array panel shown in FIG. 7 taken along lines VIIIA-VIIIA and VIIIB-VIIIB, FIGS. 10A and 10B are sectional views of the exemplary TFT array panel shown in FIG. 9 taken along lines XA-XA and XB-XB, and FIGS. 12a and 12b are sectional views of the exemplary TFT array panel shown in FIG. 11 taken along lines XIIA-XIIA and XIIB-XIIB.

As shown in FIGS. 5 to 6B a flexible substrate 110, such as a plastic substrate, is adhered on the supporter 60 using an adhesive member 50, and then a metal film is sputtered and patterned by photo-etching with a photoresist pattern on the flexible substrate 110 to form a plurality of gate lines 121 including a plurality of gate electrodes 124 and a plurality of end portions 129, and a plurality of storage electrode lines 131 including a plurality of storage electrodes 133a and 133b.

Referring to FIGS. 7 to 8B, after sequential deposition of a gate insulating layer 140, an intrinsic a-Si layer, and an extrinsic a-Si layer, the extrinsic a-Si layer and the intrinsic a-Si layer are photo-etched to form a plurality of extrinsic semiconductor stripes 164 and a plurality of intrinsic semiconductor stripes 151 including a plurality of projections 154 on the gate insulating layer 140.

Referring to FIGS. 9 to 10B, a metal film, such as a conductive layer, is sputtered and etched using a photoresist to form a plurality of data lines 171 including a plurality of source electrodes 173 and a plurality of end portions 179, and a plurality of drain electrodes 175.

Before or after removing the photoresist, portions of the extrinsic semiconductor stripes 164 which are not covered with the data lines 171 and the drain electrodes 175 are removed by etching to complete a plurality of ohmic contact stripes 161 including a plurality of projections 163 and a plurality of ohmic contact islands 165 and to expose portions of the intrinsic semiconductor stripes 151. Oxygen plasma treatment may follow thereafter in order to stabilize the exposed surfaces of the semiconductor stripes 151.

Referring to FIGS. 11 to 12B, an inorganic material is formed by plasma enhanced chemical vapor deposition (“PECVD”), or a photosensitive organic material is coated to form a passivation layer 180. The passivation layer 180 is formed on the data lines 171, the drain electrodes 175, and the exposed semiconductor stripes 151, as well as exposed portions of the gate insulating layer 140. Then, the passivation layer 180 is etched to form a plurality of contact holes 182 and 185 exposing the end portions 179 of the data lines 171 and the drain electrodes 175. The passivation layer 180 is also developed along with the gate insulating layer 140 to form a plurality of contact holes 181, 183a, and 183b exposing the end portions 129 of the gate lines 121, and the fixed and free end portions of the storage electrodes 133b of the storage electrode lines 131, respectively.

Referring to FIGS. 3 to 4B, a conductive layer preferably made of a transparent material such as ITO, IZO, or amorphous indium tin oxide (“a-ITO”) is deposited by sputtering and is etched using the photoresist to form a plurality of pixel electrodes 191 and a plurality of contact assistants 81 and 82, as well as the plurality of overpasses 83. The process forming an alignment layer (not shown) may be further added.

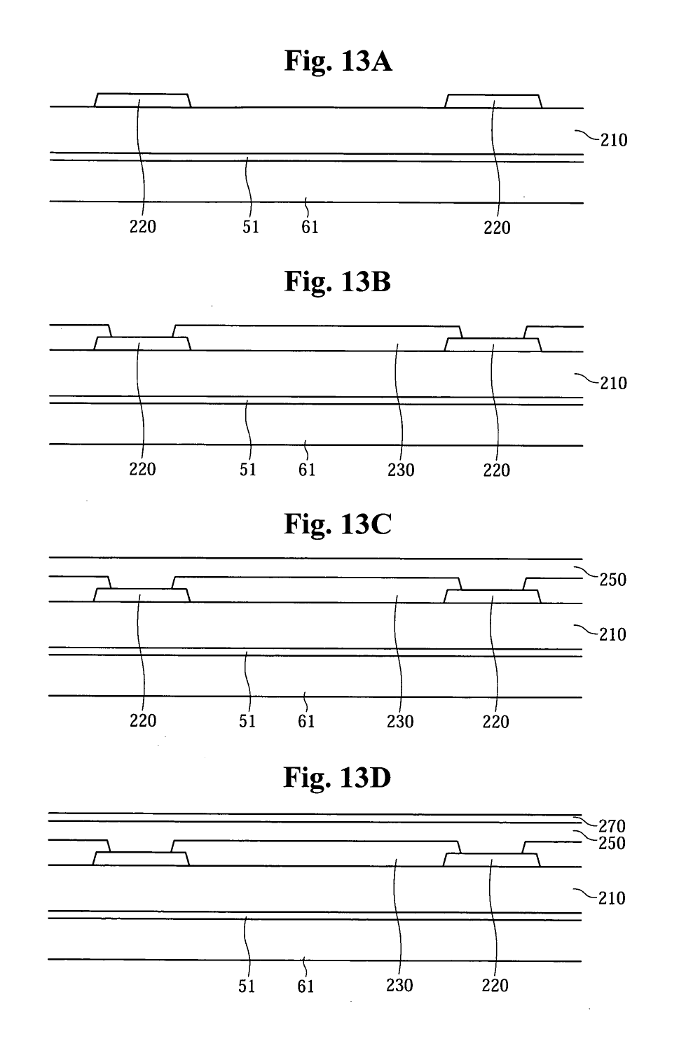

Now, an exemplary embodiment of a method of manufacturing the common electrode panel 200 shown in FIGS. 3-4B according to the present invention will be described with reference to FIGS. 13A-13D as well as FIGS. 2-4A.

As shown in FIG. 13A, a flexible substrate 210, such as a plastic substrate, is adhered on a supporter 61 using an adhesive member 51, then a thin film having good characteristics for blocking light is deposited and patterned by photo-etching with a photoresist pattern on the flexible substrate 210 to form a light blocking member 220.

As shown in FIG. 13B, photosensitive compositions are coated and patterned by photo-etching on the flexible substrate 210 to form a plurality of color filters 230 representing colors such as, but not limited to, red, green, and blue colors.

Then, as shown in FIGS. 13C and 13D, an overcoat 250 is formed on the color filters 230 and the light blocking member 220, and a common electrode 270 preferably made of a transparent conductive material is formed on the overcoat 250.

Next, the TFT array panel 100 and the common electrode panel 200 are combined with each other, and liquid crystal material is injected between the TFT array panel 100 and the common electrode panel 200. At this time, the step of forming a liquid crystal layer 3 by dripping liquid crystal material on one of the two panels 100 and 200 may be added before combining the two panels 100 and 200.

Finally, the supporters 60 and 61 are cut along cutting lines formed on the two panels 100 and 200 to divide each panel pair from other panel pairs, where each panel pair forms a display device, and the supporters 60 and 61 are respectively removed from the panels 100 and 200. At this time, the adhesive strength of the adhesive members 50 and 51 is reduced to separate the supporters 60 and 61 from the LCD using various methods such as controlling temperature, using solvent, or irradiating ultra violet rays thereon.

Alternately, instead of cutting the supporters 60 and 61, the combined panels 100 and 200 may be divided into separate displays after removing the supporters 60 and 61 from the two panels 100 and 200.

In the method of FIGS. 1A to 21, the thin film pattern 70 may include organic thin film transistors including organic semiconductors.

Furthermore, the method of FIGS. 1A to 21 as described above may be adapted to a panel for an OLED as well as the LCD.

As shown in the above descriptions, the production yield of a flexible display device may be improved and the manufacturing process is more precise and easier.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A method of manufacturing a flexible display device, the method comprising:
adhering a first flexible mother substrate to a first supporter;
cutting the first flexible mother substrate to divide the first flexible mother substrate into a plurality of first substrates; and
forming a thin film pattern on the first substrates.

2. The method of claim 1, wherein the first flexible mother substrate is made of a plastic material.

3. The method of claim 1, further comprising:
adhering a second flexible mother substrate to a second supporter;
cutting the second flexible mother substrate to divide the second flexible mother substrate into a plurality of second substrates;
forming a thin film pattern on the second substrates;
combining the first and the second substrates, respectively attached to the first and the second supporters;
cutting the first and the second supporters along a cutting line of the first and the second substrates; and
removing the first and the second supporters from the first and the second substrates.

4. The method of claim 3, further comprising forming a liquid crystal layer between the first and the second substrates.

5. The method of claim 3, further comprising reducing an adhesive strength between the first and second supporters and the first and second substrates prior to removing the first and second supporters from the first and second substrates, respectively.

6. The method of claim 5, wherein reducing the adhesive strength includes one of controlling temperature, using solvent, and irradiating ultra violet rays.

7. The method of claim 1, further comprising:
adhering a second flexible mother substrate to a second supporter;
cutting the second flexible mother substrate to divide the second flexible mother substrate into a plurality of second substrates;
forming a thin film pattern on the second substrates;
combining the first and the second substrates, respectively attached to the first and the second supporters; and
removing the first and the second supporters from the first and second substrates to respectively divide the first and second substrates into separate substrate pairs.

8. The method of claim 7, further comprising forming a liquid crystal layer between the first and the second substrates.

9. The method of claim 7, further comprising reducing an adhesive strength between the first and second supporters and the first and second substrates prior to removing the first and second supporters from the first and second substrates, respectively.

10. The method of claim 9, wherein reducing the adhesive strength includes one of controlling temperature, using solvent, and irradiating ultra violet rays.

11. The method of claim 1, wherein adhering the first flexible mother substrate to the first supporter comprises using a double-sided adhesive tape.

12. The method of claim 11, wherein cutting the first flexible mother substrate including cutting the first flexible mother substrate and the adhesive tape together.

13. The method of claim 1, wherein cutting the first flexible mother substrate includes using a laser cutter.

14. The method of claim 1, further comprising coating the first flexible mother substrate with a hard-coating layer.

15. The method of claim 14, wherein the hard-coating layer includes acrylic resin.

16. The method of claim 1, further comprising providing the first flexible mother substrate with:
an organic layer;
an under-coating layer formed on both surfaces of the organic layer;
a barrier layer formed on the under-coating layer; and
a hard-coating layer formed on the barrier layer.

17. The method of claim 16, wherein the organic layer is made of one material selected from polyacrylate, polyethylene-ether-phthalate, polyethylene-naphthalate, polycarbonate, polyarylate, polyether-imide, polyethersulfone, and polyimides.

18. The method of claim 16, wherein the under-coating layer and the hard-coating layer include acrylic resin.

19. The method of claim 16, wherein the barrier layer includes SiO₂ or Al₂O₃.

20. The method of claim 1, wherein the first supporter includes glass.

21. The method of claim 1, wherein forming the thin film pattern includes forming an inorganic emitting layer.

22. The method of claim 1, wherein forming the thin film pattern includes forming amorphous silicon thin film transistors.

23. The method of claim 1, wherein forming the thin film pattern includes forming organic thin film transistors.

24. The method of claim 1, wherein forming the thin film pattern includes spin coating.

25. The method of claim 1, wherein the first supporter is not divided during cutting the first flexible mother substrate to divide the first flexible mother substrate into a plurality of first substrates.

26. The method of claim 1, wherein a plurality of flexible display devices are substantially simultaneously formed, each flexible display device including one of the first substrates.

27. A method of manufacturing a plurality of flexible display devices, the method comprising:
adhering a plurality of first flexible substrates to a first supporter;
forming a thin film pattern on the plurality of first flexible substrates; and
removing a plurality of display device units from the first supporter, wherein each display device unit includes one of the plurality of first flexible substrates.

28. The method of claim 27, wherein adhering the plurality of first flexible substrates to a first supporter includes providing a first supporter of an inflexible material having a greater periphery than a periphery of the plurality of first flexible substrates arranged on the first supporter.

29. The method of claim 27, further comprising:
adhering a plurality of second flexible substrates to a second supporter;
forming a thin film pattern on the plurality of second flexible substrates; and,
combining the first and the second flexible substrates, respectively attached to the first and second supporters;
wherein removing the plurality of display device units from the first supporter further includes removing the plurality of display device units from the second supporter, each display device unit including one of the plurality of first flexible substrates and one of the plurality of second flexible substrates.

30. The method of claim 29, further comprising dividing the first and second supporters along lines between adjacent first flexible substrates and adjacent second flexible substrates, respectively, prior to removing the plurality of display device units from the first supporter and the second supporter.
